(19) United States
(12) Patent Application Publication
(10) Pub. No.: US 2009/0286586 A1
(43) Pub. Date: Nov. 19, 2009

(54) Icon Selection Bonus Game with Replaceable Icons

(76) Inventors: Jorge Heymann, Buenos Aires (AR); Matias Montero, Buenos Aires (AR)

Correspondence Address: MUSKIN & CUSICK LLC, 100 West Main Street, SUITE 205, Lansdale, PA, 19446, US

(21) Appl. No.: 12/122,110

(22) Filed: May 16, 2008

(51) Int. Cl. A63F 13/00; A63F 9/24

(52) U.S. Cl. 463/20

(57) ABSTRACT

A slot machine game that allows the player to continuously select icons which reveal respective content which comprise awards. If revealed content is a refill symbol, then some or all previously selected icons are replaced with replacement icons. The replacement icons can be placed in same or different locations as previously selected icons. The replacement icons can also be associated with the same awards as the previously selected icons.

### CROSS REFERENCE TO RELATED APPLICATIONS

This application is related to the following nine applications identified by their application serial numbers: Ser. No. 11/035,691 (“Slot Machine Game that Allows Player to Purchase Reel Respins”); Ser. No. 11/326,125 (“Slot Machine Bonus Game); Ser. No. 11/337,960 (“Slot Machine with Skill Aspect”); Ser. No. 11/609,315 (“System and Method for Allowing Piggyback Wagering”); Ser. No. 11/459,253 (“Slot Machine Bonus Game”); Ser. No. 11/558,564 (“System and Method for Administering a Progressive Jackpot Limited to a Bonus Round”); Ser. No. 11/678,050 (“Slot Machine Game With Additional Features”); Ser. No. 11/764,689 (“Slot Machine Game with Additional Award Indicator); Ser. No. 11/776,508 (“Slot Machine Game with User Selectable Themes”). All nine of these applications are incorporated by reference herein in their entireties for all purposes. Any and all features of any of these applications can be combined with each other and with any feature(s) described herein.

### FIELD OF THE INVENTION

The present inventive concept relates to a slot machine game which provides for an icon selection bonus round which has an operation to replace icons that were already selected.

### DESCRIPTION OF THE RELATED ART

Slot machine games are known in the art which have bonus rounds. A bonus round is an additional game that can be triggered by achieving a predetermined combination on slot machine reels. Bonus games should ideally be fun for the player to play as well as giving the player potential to win additional money.

Bonus rounds are known which allow the player to continuously select icons displayed on an output device and revealing awards hidden behind each icon until the player selects an icon which reveals a bonus round terminator symbol. As the player continues to select icons, the player gets worried because the player knows the terminator symbol will be more and more likely to be selected as the number of available icons to select decreases. If the player has selected all symbols but for one, then the player knows with certainty that the remaining symbol must be the terminator symbol.

What is needed is a game in which a player can enjoy a bonus round with a feature which can address the player concern of not having to worry about a high likelihood of achieving an undesirable symbol. What is also needed is a game which players find to be enjoyable and exciting.

### SUMMARY OF THE INVENTION

It is an aspect of the present general inventive concept to provide an exciting slot machine bonus game.

The above aspects can be obtained by a method that includes (a) receiving an initial wager from a player to play a slot machine game; (b) initiating a bonus game; (c) displaying at least two displayed selectable icons; (d) inputting, from the player, a selected icon out of the displayed icons and displaying associated content associated with the selected icon; (e) determining if the associated content results in termination of the bonus game, and if so, terminating the bonus game; (f) judging if the associated content is a refill symbol, and if so, displaying at least one replacement selectable icon(s) to replace the selected icon(s); (g) repeating the inputting, determining, and judging; and (h) awarding an award, the award determined using the associated content.

The above aspects can also be obtained by a method that includes (a) receiving a wager from a player; (b) displaying selectable elements; (c) continuously allowing the player to select elements out of the displayed selectable elements thereby revealing associated content comprising awards associated with the selected elements, wherein if a refill symbol is revealed as associated content then replacement selectable elements are displayed to replace selected elements; and (d) awarding an award to the player determined using the revealed content.

The above aspects can also be obtained by a method that includes (a) receiving a wager from a player; (b) displaying selectable elements; (c) continuously allowing the player to select elements out of the displayed selectable elements thereby revealing associated content comprising awards associated with the selected elements, wherein if the player elects to pay a refill purchase price, then replacement selectable elements are displayed to replace selected elements; an (d) awarding an award to the player determined using the revealed content.

The above aspects can also be obtained by an apparatus that includes (a) a processor performing: (b) receiving a wager from a player; (c) displaying selectable elements; (d) continuously allowing the player to select elements out of the displayed selectable elements thereby revealing associated content comprising awards associated with the selected elements, wherein if a refill symbol is revealed as associated content then replacement selectable elements are displayed to replace selected elements; (e) awarding an award to the player determined using the revealed content; and (f) an output device outputting results of the processor.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a game output illustrating an exemplary output of an initial stage of a bonus round, according to an embodiment;

FIG. 2 is a game output illustrating an exemplary output after a first action, according to an embodiment;

FIG. 3 is a game output illustrating an exemplary output after a second action, according to an embodiment;

FIG. 4 is a game output illustrating an exemplary output after a third action, according to an embodiment;

FIG. 5 is a game output illustrating an exemplary output after an alternative third action, according to an embodiment;

FIG. 6 is a game output illustrating an exemplary output after a refill operation, according to an embodiment;

FIG. 7 is a game output illustrating an exemplary output after a refill operation which adds icons, according to an embodiment;

FIG. 8 is a game output illustrating an exemplary output after a refill operation which doesn't replace all icons, according to an embodiment;

FIG. 9 is a game output illustrating an exemplary output illustrating a purchase of a refill operation, according to an embodiment;

FIG. 10 is a flowchart illustrating an exemplary method of implementing a game with a refill operation, according to an embodiment;

FIG. 11 is a flowchart illustrating an exemplary method of implementing a refill operation, according to an embodiment; and

FIG. 12 is a block diagram illustrating one example of hardware that can be used to implement embodiments described herein.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

Embodiments of the present inventive concept relate to a bonus game which can be triggered as part of an overall slot game, although the methods described herein can be used to an individual stand-alone game as well. A bonus game is a game which is typically triggered when a player of a slot machine game places a wager and spins reels which result in a predetermined combination. The predetermined combination triggers the bonus game, upon which play of the main slot game is temporarily suspended while the player gets the enjoyment of playing the bonus round.

The bonus game herein allows a player to continuously select icons (or elements), of which each icon is associated with content that is “behind” its respective icon. As each icon is selected (typically touched on a touch screen), the icon disappears to reveal the icon's associated content (e.g., award or other item hidden behind the icon). Examples of content can be an award (e.g., $5, 10 credits, etc.), a multiplier (e.g., the final bonus award is multiplied by a particular value), a termination symbol (which ends the bonus round), nothing (e.g., nothing happens), etc. Another type of content can be a “refill” symbol. The refill symbol operates to replace icons which have already been selected (and typically removed) with new replacement selectable icons. The replacement selectable icons can be selected just as the prior selected icons can be. There typically would not be any operational difference between a replacement selectable icon and an original selectable icon that was displayed to the player when the bonus round was initially displayed.

Typically, bonus rounds can be terminated by a termination symbol. For example, once an icon that is associated with a termination symbol is selected by the player, the bonus round would typically end, and any award(s) that the player has earned during the bonus round would be awarded to the player. Other conditions can be used to terminate bonus rounds, such as multiple termination symbols would be required to be selected to terminate the bonus round. Alternatively, selecting particular symbols which award prizes may terminate the bonus round (even though the symbol selected is not itself a termination symbol).

When playing a bonus round using termination symbol(s) which terminates the bonus round, as the player continues to select icons, the probability of selecting a termination symbol increases. This can be a source of frustration for the player, as the player does not wish to select a termination symbol but knows his chances are getting more likely.

In an embodiment, a refill symbol can address this issue by replacing already selected icons with replacement (new) selectable icons. In this way, the player is not limited to selecting icons that the player previously did not select but can now also select the replacement selectable icons. Thus, the player is free to select the original icons that were displayed originally as well.

The refill symbol allows the player to experience an exciting type of bonus round, since the player would now have an opportunity to continue selecting icons indefinitely (until icons are selected which terminate the bonus round). Thus, without a refill symbol, if a bonus round displays 15 icons, then the bonus round must end after the fifteenth icon is selected (if it doesn't end sooner). With the possibility of getting a refill symbol, the bonus round is not limited to the player selecting 15 icons, because if the player gets a refill symbol, icons that were already selected are replaced, thus allowing the player to continue to select icons indefinitely.

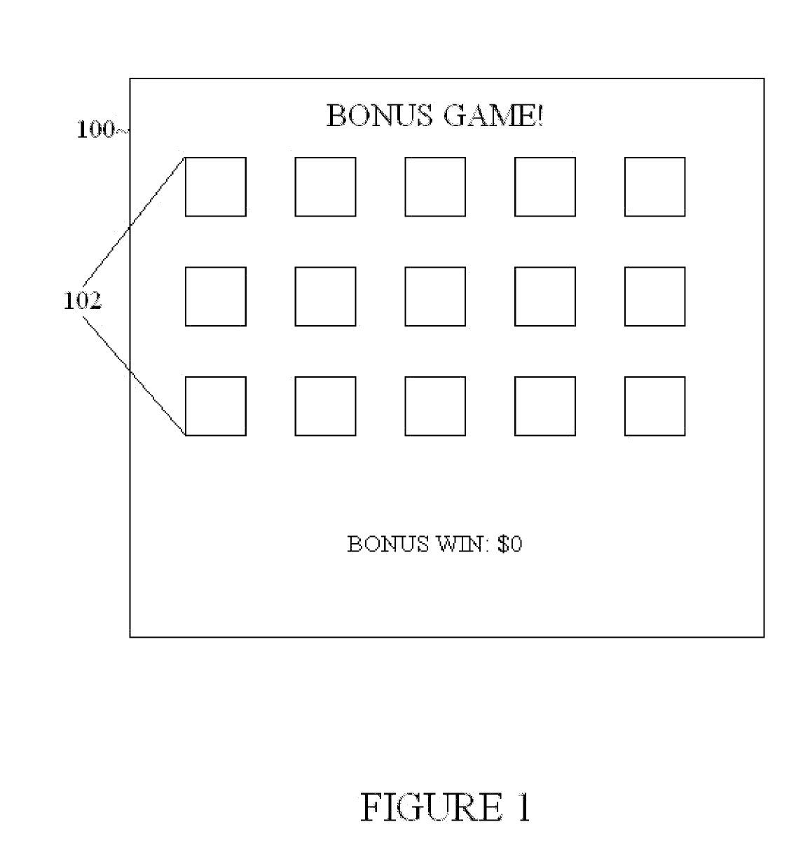

FIG. 1 is a game output illustrating an exemplary output of an initial stage of a bonus round, according to an embodiment.

A bonus game output 100 shows a bonus grid 102 of 15 selectable icons. Any number of icons can be used. The player is free to select (typically by touching on a touch screen, although any other method can be used as well) any displayed icon which will reveal content behind that icon (and typically erase the selected icon). Content behind icons can be predetermined or can be determined at such time as the player selects a selected icon.

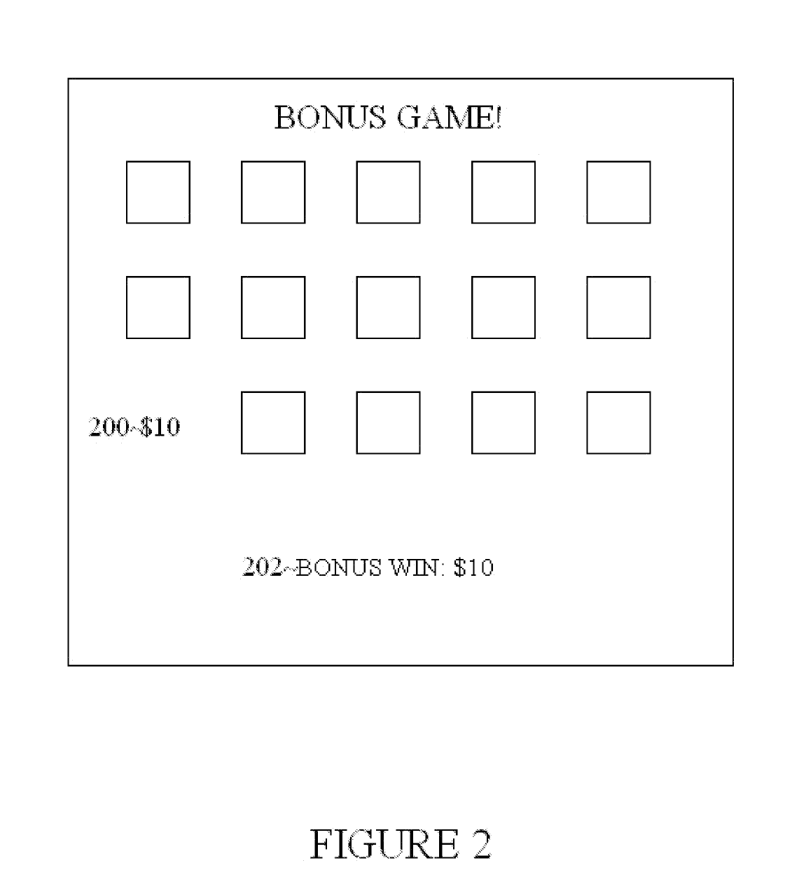

FIG. 2 is a game output illustrating an exemplary output after a first action, according to an embodiment.

The player has selected the bottom left icon, which reveals a $10 award 200 as the selected icon's associated content. A total award meter 202 can display the total award that the player has earned during the bonus game (or bonus round). Once an icon is selected, it typically becomes inactive and it is no longer selectable again (unless it is refilled, as described herein). A selected icon typically is visually different (e.g., it disappears, changes color/shape, etc.) so that the player can readily discern that previously selected icons cannot be selected again. If such a previously selected icon is touched again, typically it would have no effect.

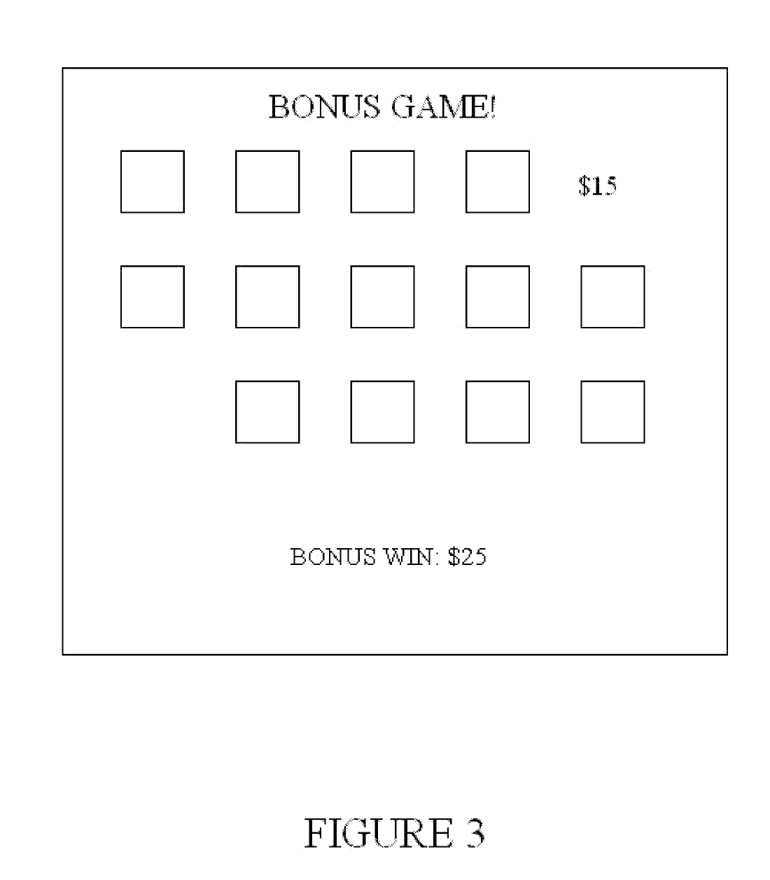

FIG. 3 is a game output illustrating an exemplary output after a second action, according to an embodiment.

From FIG. 2, the player now continues to play the bonus game and selects the upper right icon, which reveals a $15 award.

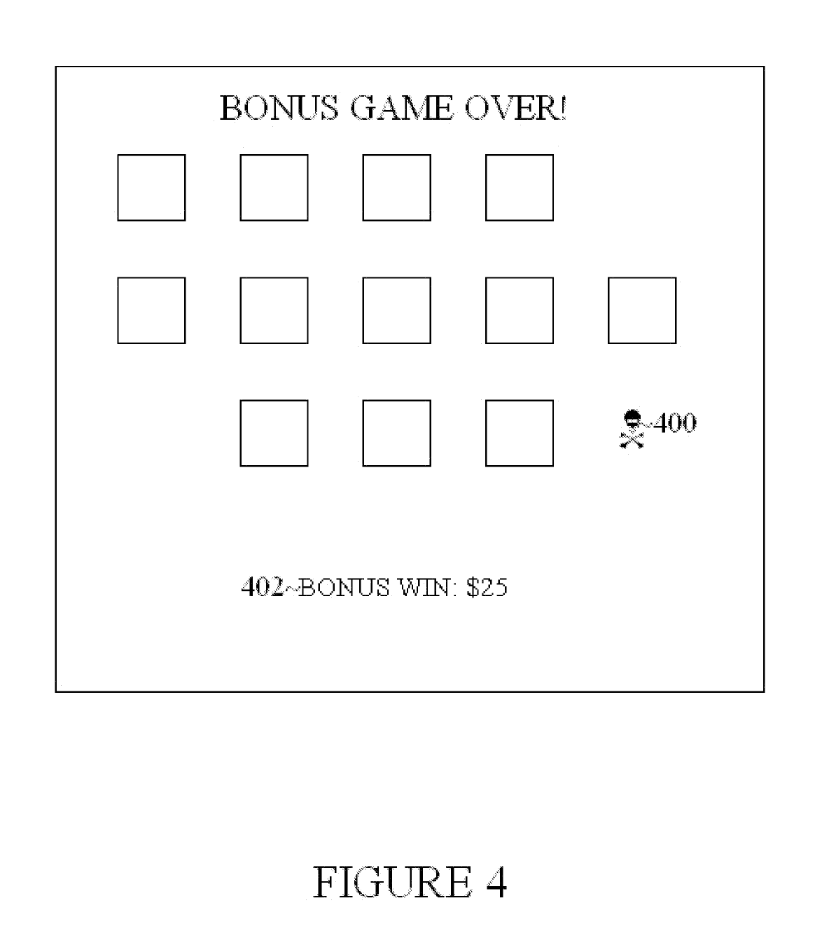

FIG. 4 is a game output illustrating an exemplary output after a third action, according to an embodiment.

From FIG. 3, the player now continues to play the bonus game and selects the bottom right icon which reveals a termination symbol 400 (depicted herein as a skull and crossbones) which ends the bonus round.

In this embodiment, the bonus round has now ended and the player has won $25 which can be added to the player's credit meter or disbursed as cash to the player. The gaming device then would typically return the player to an original main game (e.g., a reeled slot machine wherein the player spins reels).

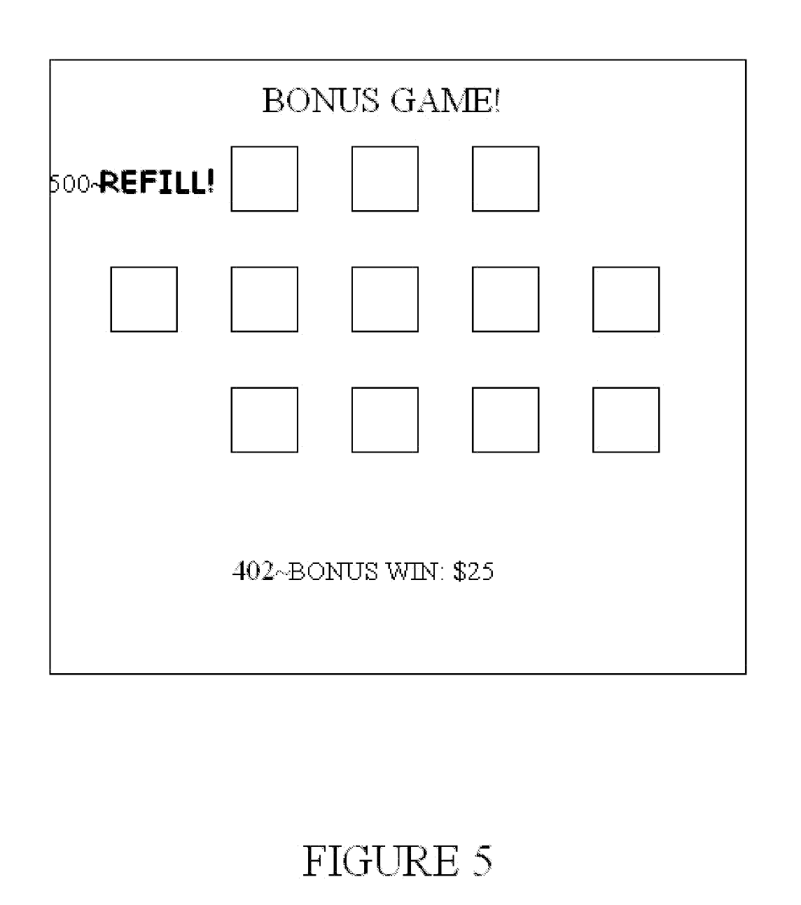

FIG. 5 is a game output illustrating an exemplary output after an alternative third action, according to an embodiment.

Returning to FIG. 3, instead of selecting the bottom right icon (which was the termination symbol), consider that the player selects the top left icon which reveals a refill symbol 500. The refill symbol 500 will have the effect of replacing the icons that were previously selected by the player (the bottom left, the top right, and optionally the top left).

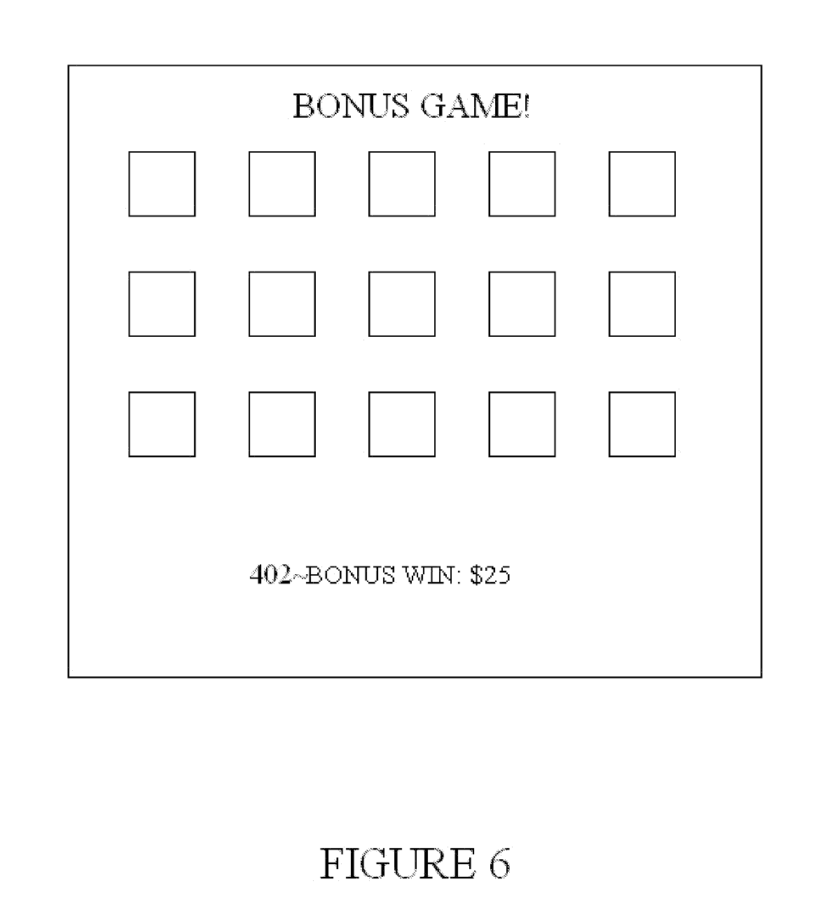

FIG. 6 is a game output illustrating an exemplary output after a refill operation, according to an embodiment.

A refill operation has occurred, which replaces all of the selected symbols with replacement selectable symbols. The player is now free to select any of the fifteen replacement selectable symbols. In an alternate embodiment, the icon which had the refill symbol associated with it (the upper left icon) would not be replaced with a replacement icon. The symbols can be replaced immediately, or can be replaced slowly (e.g., one icon by one icon) in order to provide the player with some visual effects.

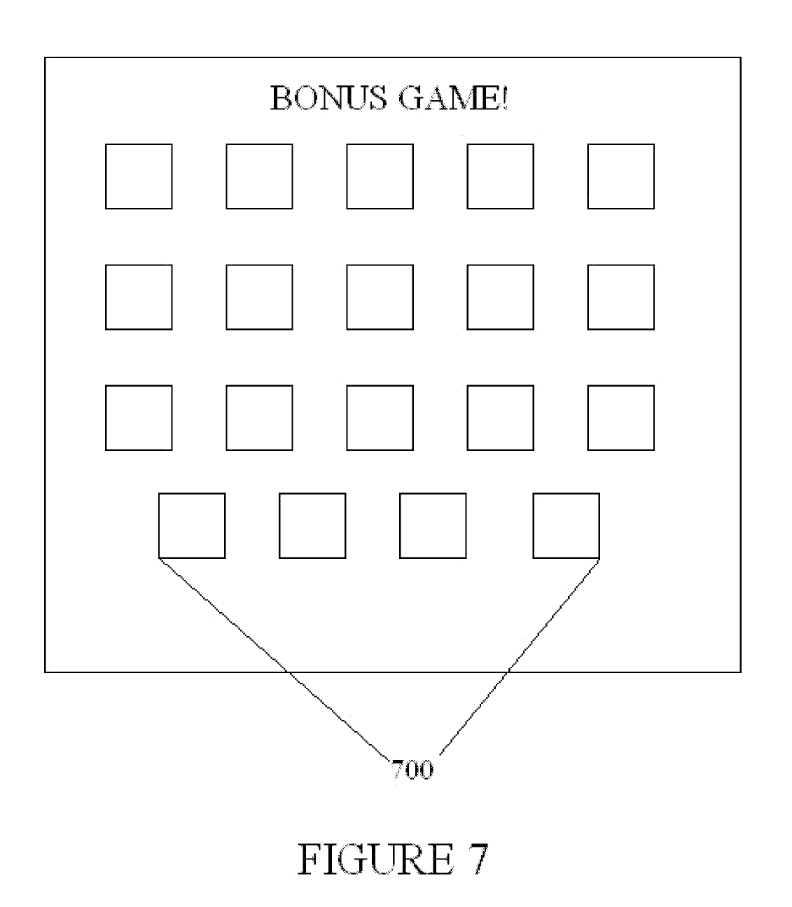

FIG. 7 is a game output illustrating an exemplary output after a refill operation which adds icons, according to an embodiment.

A refill operation has occurred, but unlike the refill operation illustrated in FIG. 6, this refill operation adds additional icons not present in the original bonus grid (see FIG. 1 for an original bonus grid).

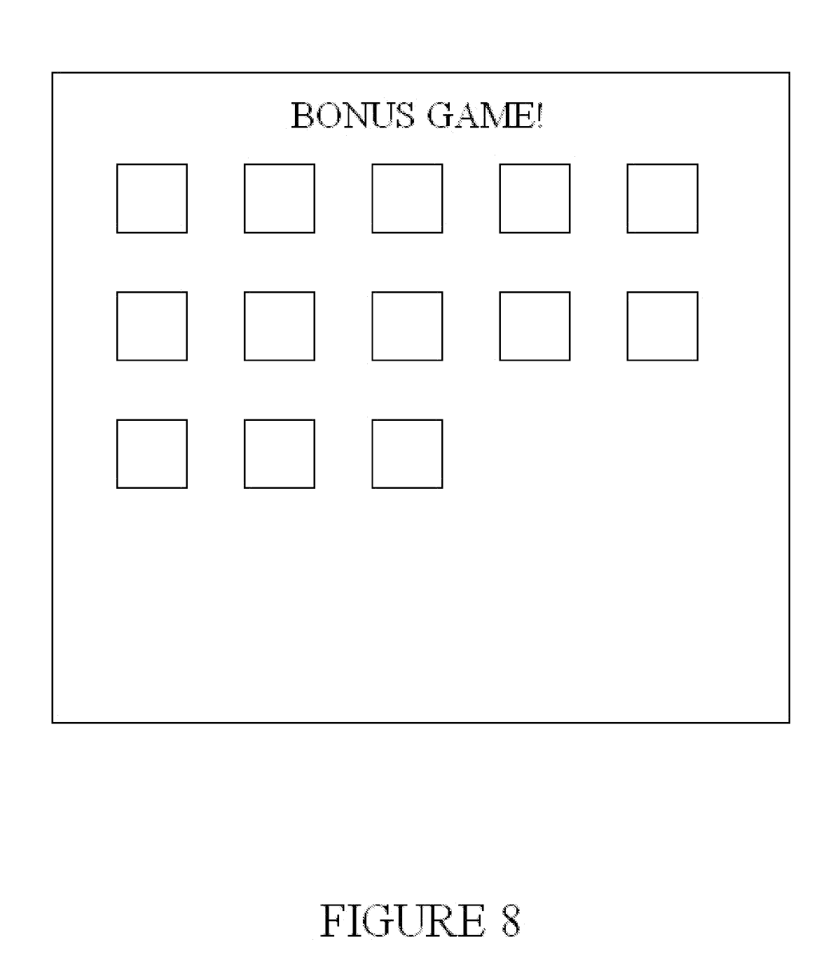

FIG. 8 is a game output illustrating an exemplary output after a refill operation which doesn't replace all icons, according to an embodiment.

A refill operation has occurred, but unlike the refill operation illustrated in FIG. 6, this refill operation does not replace all of the icons present in the original bonus grid (see FIG. 1 for an original bonus grid).

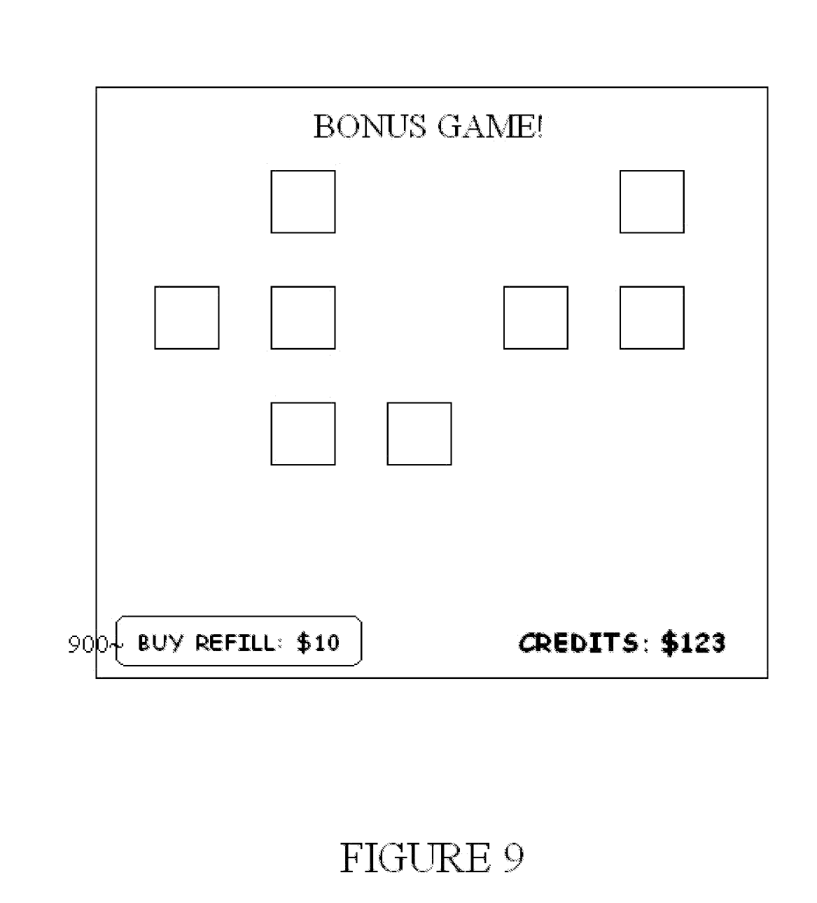

FIG. 9 is a game output illustrating an exemplary output illustrating a purchase of a refill operation, according to an embodiment.

In this embodiment, a refill operation can be purchased by the player by paying (having deducted from the credit meter) a number of credits (e.g., $10). The player may wish to do this if the player has revealed a large number of icons and then feels that a terminator symbol is likely to be revealed such that it might be worth the money for the player to add new symbols, thus reducing the chances of a terminating the bonus round.

A purchase refill button 900 can be pressed by the player in order to purchase a refill operation. In this example, the player can press the purchase refill button 900, have $10 (or any other refill purchase price) deducted from the credit meter (or other award indicator), and receive a refill operation (any kind as described herein). In addition to the purchase option, refill symbols can still be available as associated content with a selected icon, or alternatively refill symbols will not be available as associated content and thus the only way for a player to receive a refill operation is by purchase.

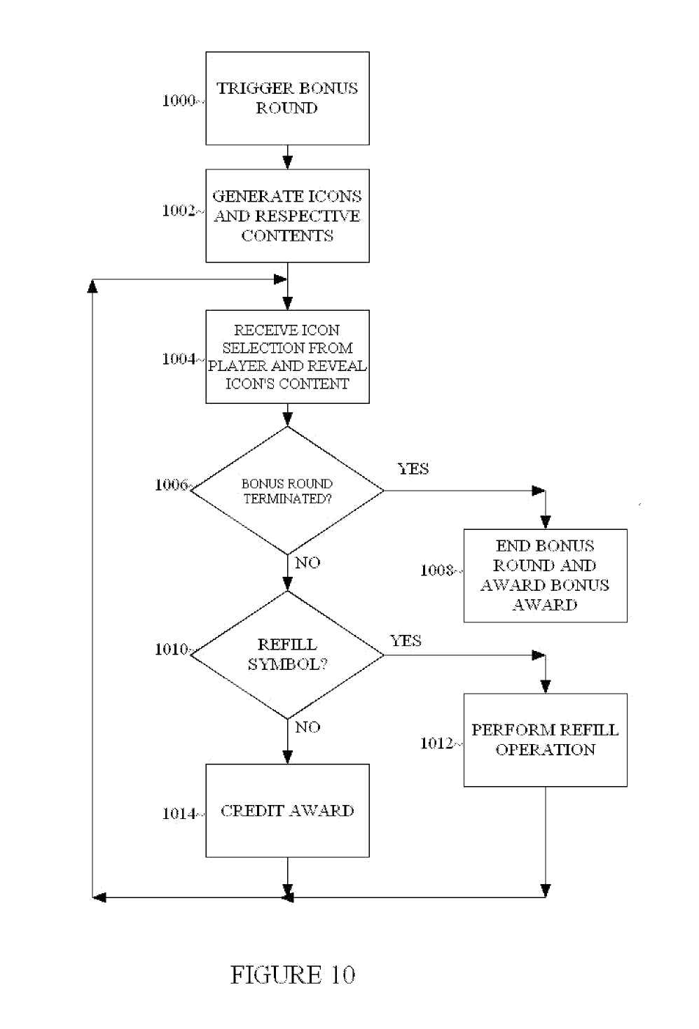

FIG. 10 is a flowchart illustrating an exemplary method of implementing a game with a refill operation, according to an embodiment.

The method can begin with operation 1000, which triggers a bonus. This can be done as known in the art. For example, a player places a wager, spins reels on a slot machine, and if the resulting reel position forms a predetermined combination which triggers a bonus round, then the bonus round is triggered.

From operation 1000, the method proceeds to operation 1002, which initiates the bonus round by generating icons and respective contents for each icon. This results in a display such as that in FIG. 1. In an alternate embodiment, the respective contents for each icon do not have to be generated until such icons are actually selected by the player.

From operation 1002, the method proceeds to operation 1004, which receives an icon selection from the player and reveals the icon's content. For example, the player touches an icon of the player's choosing, and the icon disappears (or changes shape, etc.) and reveals an award behind it.

From operation 1004, the method proceeds to operation 1006, which determines whether the bonus round is terminated. This can be done as described herein, such as checking to see whether the last content revealed in operation 1004 terminates the bonus round (either by itself or in conjunction with prior revealed contents from selected icons). If the bonus round is terminated, then the method proceeds to operation 1008, which ends the bonus round and awards the bonus award to the player.

If the determination in operation 1006 determines that the bonus round is not terminated, then the method proceeds to operation 1010 which determines whether the revealed content from operation 1004 is a refill symbol. Alternatively, operation 1010 can determine whether a refill operation was purchased by the player (see FIG. 9 and accompanying description).

If the revealed content is a refill symbol, then the method proceeds to operation 1012 which performs a refill operation, as described herein (e.g., see the transition between FIG. 5 and FIG. 6). The refill operation replaces icons (or areas on the screen where icons used to be before they were selected) that had already been selected with new icons that can now be selected by the player. Thus, for example, if a refill operation wasn't initiated after FIG. 5 occurred, then the player has twelve icons he or she can choose from. After a refill operation, the player can have 15 (or any number of) icons in which to choose to select, since the icons have been “refilled.” Thus, by refilling, there are no inactive icons (or inactive areas on the screen where a selected icon used to be). Once the refill operation is performed, the method can return to operation 1004, which continues to allow the player to select further icons.

If in operation 1010, the content revealed by the last icon selected did not reveal a refill symbol, then the method can proceed to operation 1014, which will credit any award earned by the content. The content may or may not contain an award (e.g., the last icon touched may reveal nothing, a credit award (e.g., $5), or another operation). All of the awards earned are accumulated and are awarded to the player immediately or after the bonus round is over (in operation 1008).

After any award, if earned, is credited to the player in operation 1014, the method returns to operation 1004, wherein the player can continue to select icons.

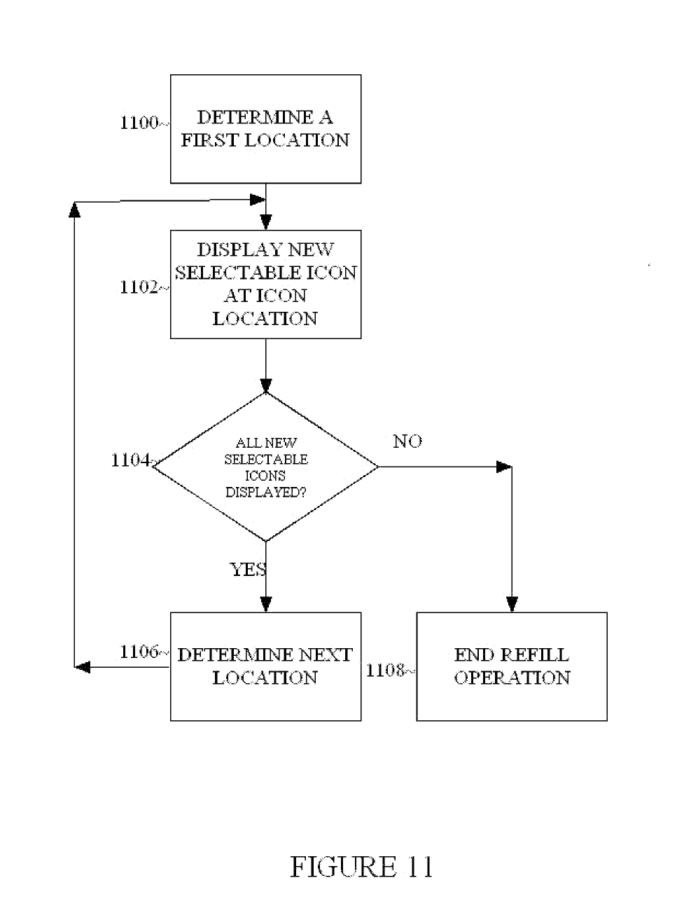

FIG. 11 is a flowchart illustrating an exemplary method of implementing a refill operation, according to an embodiment. This method would be performed after a refill symbol has been revealed. This represents just one method of implementing a refill operation, many other algorithms could of course be used as well.

The method can begin with operation 1100, which identifies a first location for a new selectable icon to be placed. The first location is not the location for the icon that was selected by the player first in the bonus game (although it can be), but a starting location to place a first new selectable icon on the bonus grid. This can be determined, for example, by using a location for a previously selected icon, or a random location, etc.

From operation 1100, the method can proceed to operation 1102, which displays a new selectable icon in the place of the icon location determined in either operation 1100 or 1106 (whichever was performed more recently). Depending on the embodiment, the associated contents of the new selectable icon (e.g., any award, etc.) can be determined when the new selectable icon is displayed, or it can be determined at a later time (such as when the icon happens to be selected by the player).

In a further embodiment, replacement icons do not necessarily have to be placed in the same location that previously selected icons were located, but can be placed in new locations as well, such as random locations, locations outside of the original bonus grid, etc.

From operation 1102, the method proceeds to operation 1104, which determines whether all of the new selectable icons to be generated have in fact been generated (e.g., the refill operation is complete). This can be done by evaluating the number of new icons displayed to see if a particular number has been generated, for example: if all original icons that were selected by the user have been replaced, or if all original icons that were selected by the user (but for the last icon) have been replaced, or if a random number of icons that were selected by the user have been replaced, or any other number.

Alternatively, a refill operation can refill (replace) up to X icons (where X can be any number, for example less than the number of original icons or more than the number of original icons). For example, if there are originally 15 icons (such as in FIG. 1), and the player selects a tenth icon which then reveals a refill symbol, instead of refilling (replacing) 10 symbols to replace all the symbols, 3 symbols (or any number less than 10, the number of icons already selected) can be replaced, which would still leave some blank symbols. Alternatively, if there are originally 15 icons (such as in FIG. 1), and the player selects a tenth icon which then reveals a refill symbol, in addition to refilling (replacing) 10 symbols to replace all the symbols, additional symbols (e.g., 4) can be added to the bonus grid as well (which would now result in 19 selectable icons).

If the determination in operation 1104 determines that not all selectable icons have been generated (e.g., the refill operation is not complete), then the method proceeds to operation 1106, which determines a next new location for the next new selectable icon to be placed. The next new location can be a location of a previously selected icon, or randomly determined, etc. Note that the new location should not be a same location used previously for a new selectable icon in this operation (e.g., new icons should typically not overlap one another). From operation 806, the method returns to operation 1102.

If the determination in operation 1104 determines that all new selectable icons have been displayed, then the method can proceed to operation 1108, which ends the refill operation.

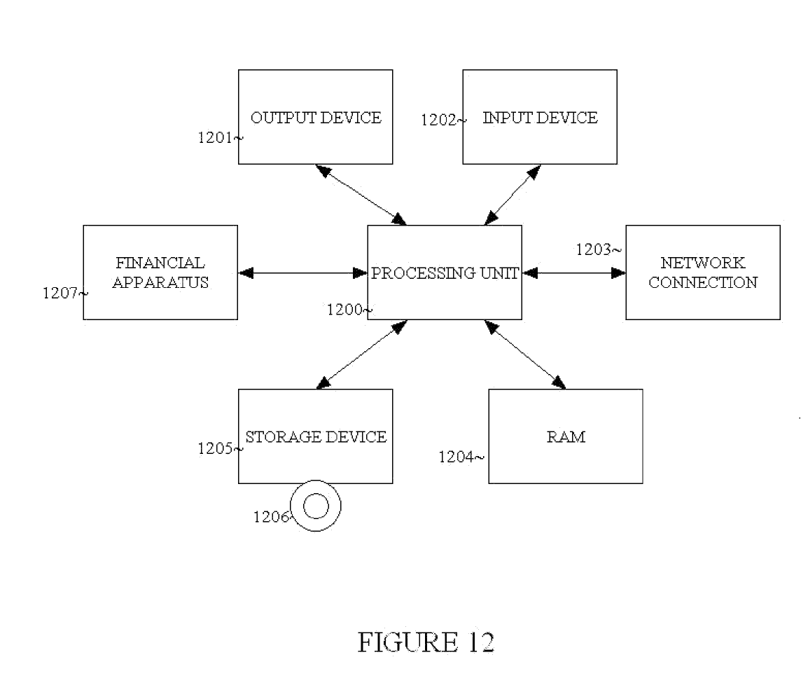

FIG. 12 is a block diagram illustrating one example of hardware that can be used to implement embodiments described herein.

A processing unit 1200 can be a microprocessor and any associated apparatus (e.g., cache, etc.) The processing unit 1200 is connected to an output device 1201, which can be any output device, such as a touch screen monitor, LCD, CRT, etc. The output device 1201 can display results of the processing unit 1200, such as the reels spinning and their initial outcome and final outcome, awards won, any outputs described herein or known in the art, etc. The processing unit 1200 is also connected to an input device 1202, which can be any input device such as a touch screen monitor, keyboard, mouse, buttons, etc. The processing unit 1200 can also be connected to a network connection 1203 which can connect to the Internet, an LAN, WAN, or any computer communications network. The processing unit 1200 can also be connected to a RAM 904 and a storage device 1205 (e.g., hard drive, DVD-drive, CD-ROM, flash memory, etc.) which can also read a computer readable storage medium 1206 such as a CD or DVD. The processing unit 1200 can also be connected to a financial apparatus 1207 which can be used to accept payments from the player (e.g., a bill collector which receives cash from the player and converts it into player credits), a coin dispenser (which pays winnings to the players in the form of coins), etc.

Any type of slot machine game can be used with the methods described herein, including video slot machines or mechanical, finite or random, etc. Players can wager for real cash and get paid in real cash or tokens which can be exchanged for cash in a casino. All of the methods described herein can be effectuated in any order, and any operation not necessary for the operation of the method may be optional.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to play a slot machine, the method comprising:
receiving an initial wager from a player to play a slot machine game;
initiating a bonus game;
displaying at least two displayed selectable icons;
inputting, from the player, a selected icon out of the displayed icons and displaying associated content associated with the selected icon;
determining if the associated content results in termination of the bonus game, and if so, terminating the bonus game;
judging if the associated content is a refill symbol, and if so, displaying at least one replacement selectable icon(s) to replace the selected icon(s);
repeating the inputting, determining, and judging; and
awarding an award, the award determined using the associated content.

2. The method as recited in claim 1, wherein the replacement selectable icons are associated with respective content.

3. The method as recited in claim 1, wherein if the judging judges that the selected icon's respective content is a refill symbol, then replacing all selected icons with respective replacement selectable icons.

4. The method as recited in claim 2, wherein if the judging judges that the selected icon's respective content is a refill symbol, then replacing all selected icons with respective replacement selectable icons but for a last selected icon associated with the refill symbol.

5. The method as recited in claim 3, wherein a set of the respective contents for the replacement selectable icons equals a set of the respective contents for the selected icons.

6. The method as recited in claim 3, wherein the respective contents for the replacement selectable icons are determined randomly.

7. The method as recited in claim 1, wherein the replacement selectable icon(s) are displayed in same location(s) as the selected icon(s).

8. The method as recited in claim 1, wherein the replacement selectable icon(s) are displayed in different location(s) than the selected icon(s).

9. A method to play a wagering game, the method comprising:
receiving a wager from a player;
displaying selectable elements;
continuously allowing the player to select elements out of the displayed selectable elements thereby revealing associated content comprising awards associated with the selected elements, wherein if a refill symbol is revealed as associated content then replacement selectable elements are displayed to replace selected elements; and
awarding an award to the player determined using the revealed content.

10. The method as recited in claim 9, wherein the continuously allowing is terminated when associated content is revealed to be a termination symbol which triggers termination, wherein the content comprises termination symbols.

11. The method as recited in claim 9, wherein the displayed replacement selectable elements replace all previously selected elements including a last selected element that revealed the refill symbol.

12. The method as recited in claim 9, wherein the displayed replacement selectable elements replace all previously selected elements but for a last selected element that revealed the refill symbol.

13. The method as recited in claim 9, wherein the displayed replacement selectable elements replace less than all previously selected elements.

14. The method as recited in claim 9, wherein the displayed replacement selectable elements replace all previously selected elements plus add additional selectable elements.

15. The method as recited in claim 9, wherein a set of associated content associated with all previously selected elements is equal to a set of associated content associated with the replacement selectable elements.

16. The method as recited in claim 9, wherein the replacement selectable elements are displayed in same locations as the selected elements.

17. The method as recited in claim 9, wherein the replacement selectable elements are displayed in same locations as the selected elements.

18. The method as recited in claim 9, wherein upon purchase by the player, replacement selectable elements are displayed to replace selected elements.

19. A method to play a wagering game, the method comprising:
receiving a wager from a player;
displaying selectable elements;
continuously allowing the player to select elements out of the displayed selectable elements thereby revealing associated content comprising awards associated with the selected elements, wherein if the player elects to pay a refill purchase price, then replacement selectable elements are displayed to replace selected elements; and
awarding an award to the player determined using the revealed content.

20. An electronic gaming machine to play a wagering game, the machine comprising:
a processor performing:
receiving a wager from a player;
displaying selectable elements;
continuously allowing the player to select elements out of the displayed selectable elements thereby revealing associated content comprising awards associated with the selected elements, wherein if a refill symbol is revealed as associated content then replacement selectable elements are displayed to replace selected elements;
awarding an award to the player determined using the revealed content; and
an output device outputting results of the processor.
